(19) United States
(12) Patent Application Publication
(10) Pub. No.: US 2017/0286944 A1
(43) Pub. Date: Oct. 5, 2017

(54) SECURE TRANSFER OF PAYMENT DATA

(71) Applicant: BPAY GROUP LIMITED, Rhodes (AU)

(72) Inventor: Keith Brown, Rhodes (AU)

(21) Appl. No.: 15/513,753

(22) PCT Filed: Jun. 2, 2015
(86) PCT No.: PCT/AU2015/050301

§ 371 Date: Mar. 23, 2017

(30) Foreign Application Priority Data
Sep. 24, 2014 (AU) 2014903822

(51) Int. Cl. G06Q 20/32; H04W 12/06; G06Q 20/40; H04L 29/06; G06F 21/60; G06Q 20/38

(52) U.S. Cl. CPC G06Q 20/3223; G06F 21/606; G06Q 20/3829; G06Q 20/4014; H04L 63/168; H04L 63/18; H04W 12/06; G06Q 2220/00; H04L 9/3271

(57) ABSTRACT

This disclosure relates to a payee applications and payment applications installed on a mobile communication device. The device authenticates the payee application with a transaction server and sends transaction data to the transaction server. The device then receives from the transaction server a transaction identifier and sends the transaction identifier to a payment application installed on the mobile communication device to allow the payment application to access the transaction data from the transaction server. In response, the device receives from the payment application a payment confirmation associated with the transaction identifier and sends to the transaction server a request for payment status, the request comprising the transaction identifier. Finally, the device receives response data indicative of the payment status from the transaction server and determines a validity of the payment confirmation based on the response data from the transaction server.

### CROSS-REFERENCE TO RELATED APPLICATIONS

The present application claims priority from Australian Provisional Patent Application No 2014903822 filed on 24 Sep. 2014, the content of which is incorporated herein by reference.

### TECHNICAL FIELD

This disclosure relates to a payee applications and payment applications installed on a mobile communication device. More particularly, this disclosure relates to the payee application validating a confirmation of a payment and the payment application initiating a payment.

### BACKGROUND

A large number of consumers use online shopping to buy goods or services from a wide variety of online merchants. Many online merchants offer customised software applications (apps) for mobile communication devices, such as tablet computers or smartphones. Consumers install these applications on their personal devices to buy goods or services. As a result, more and more payments are made in those apps instead of conventional internet sites.

In order to complete a payment, a merchant application may launch a payment application, such as a banking application, and send transaction data to the banking application. The banking application may initiate the payment and send a payment confirmation back to the merchant application.

However, it is difficult for the banking application to verify the transaction data and it is difficult for the merchant application to verify the payment confirmation.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A method as performed by a payee application installed on a mobile communication device to validate a confirmation of a payment comprises:

authenticating the payee application with a transaction server;

sending transaction data to the transaction server;

receiving from the transaction server a transaction identifier;

sending the transaction identifier to a payment application installed on the mobile communication device to allow the payment application to access the transaction data from the transaction server;

receiving from the payment application a payment confirmation associated with the transaction identifier;

sending to the transaction server a request for payment status, the request comprising the transaction identifier;

receiving response data indicative of the payment status from the transaction server; and

determining a validity of the payment confirmation based on the response data from the transaction server.

Since the transaction data is sent to the transaction server after authentication and only the transaction identifier is sent to the payment application, tampering with the transaction data is made more difficult compared to other solutions and therefore, the transmission is more secure than other solutions.

The payer can use a trusted payment application, such as a banking app, and can be certain that the transaction data sent to the payment application is the true transaction data. As a result, the payer does not need to trust the payee but can rely on the trusted payment application to process the payment. In other words, the method above takes advantage of the fact that most payers interact with only a small number of payment providers, such as banks, but interact with a large numbers of payees, such as online shops, etc.

Further, the payee application validates the payment confirmation based on a response from the transaction server, which makes tampering with the payment confirmation or injecting a counterfeited payment confirmation more difficult than with other solutions.

Sending the transaction identifier may comprise sending the transaction identifier in plain text. Since the transaction identifier is sent in plain text, the payee application and the payment application do not perform encryption or decryption, which reduces the computational overhead. At the same time, the transaction identifier only identifies the transaction but does not by itself reveal any information and therefore the method is still secure against man-in-the-middle attacks. This is an advantage over encryption-based methods with high computational overhead which causes latency and reduces battery life of the mobile communication device.

The step of sending the transaction data may be performed before receiving the transaction identifier and receiving the transaction identifier may comprises receiving the transaction identifier associated with the transaction data.

The method may further comprise:

sending a request for a transaction identifier to the transaction server, wherein the steps of sending the request for a transaction identifier and receiving the transaction identifier are performed before sending the transaction data, and sending the transaction data comprises sending the transaction identifier.

The steps of sending the transaction data, receiving the transaction identifier, sending a request for payment status and receiving response data may comprise using a direct communication channel between the payee application and the transaction server.

Using the direct communication channel may comprise using an encrypted communication channel between the payee application and the transaction server. Using an encrypted communication channel may comprise using a Secure Socket Layer communication channel.

The steps of sending the transaction data, receiving the transaction identifier, sending a request for payment status and receiving response data may comprise using an indirect communication channel between the payee application and the transaction server via a payee server.

Using the indirect communication channel may comprises using an encrypted communication channel between the payee application and the payee server. Using an encrypted communication channel comprises using a Secure Socket Layer communication channel.

Sending the transaction identifier to the payment application may comprise performing a call of the payment application using the transaction identifier as a parameter value of the call. Performing a call to the payment application may comprise generating a Uniform Resource Locator comprising the transaction identifier as a parameter.

The method may further comprise in response to determining that the payment confirmation is valid, displaying a confirmation message on a display device.

Software, when installed on a mobile communication device, causes the mobile communication device to perform the above method. An Application Programming Interface, when installed on a mobile communication device as part of a payee application, causes the mobile communication device to perform the above method.

A mobile communication device comprises:

a program memory to store a payee application installed on the mobile communication device and a payment application installed on the mobile communication device;

a first data port to facilitate communication with a transaction server;

a second data port to facilitate communication between the payee application and the payment application; and

a processor to authenticate the payee application with a transaction server using the first data port;

send transaction data to the transaction server using the first data port;

receive from the transaction server a transaction identifier using the first data port;

send the transaction identifier to the payment application using the second data port to allow the payment application to access the transaction data from the transaction server using the first data port;

receive from the payment application a payment confirmation associated with the transaction identifier using the second data port;

send to the transaction server a request for payment status using the first data port, the request comprising the transaction identifier;

receive response data indicative of the payment status from the transaction server using the first data port; and

determine a validity of the payment confirmation based on the response data from the transaction server.

The mobile communication device may further comprise a display device and an input device to facilitate user interaction with the payee application and the payment application.

A method as performed by a payment application installed on a mobile communication device to initiate a payment comprises:

receiving a transaction identifier from a payee application installed on the mobile communication device;

authenticating the payment application with a transaction server;

sending to the transaction server a request for transaction data, the request comprising the transaction identifier;

receiving reply data from the transaction server associated with the transaction identifier;

determining a validity of the transaction identifier based on the reply data from the transaction server; and

in response to determining that the transaction identifier is valid
determining the transaction data based on the reply data,
initiating a payment based on the transaction data and associated with the transaction identifier,
receiving a first payment confirmation associated with the transaction identifier, and
sending a second payment confirmation associated with the transaction identifier to the payee application to allow the payee application to request payment status data from the transaction server.

Sending the payment confirmation may comprise sending the payment confirmation in plain text.

The steps of receiving the transaction identifier, sending the request for transaction data and receiving reply data may comprise using an indirect communication channel between the payment application and the transaction server via a payment server.

Software when installed on a mobile communication device causes the mobile communication device to perform the above method to initiate a payment.

A mobile communication device comprises:

a program memory to store a payee application installed on the mobile communication device and a payment application stored on the mobile communication device;

a first data port to facilitate communication with a transaction server;

a second data port to facilitate communication between the payee application and the payment application; and

a processor to
receive a transaction identifier from a payee application installed on the mobile communication device using the second data port,
authenticate the payment application with a transaction server using the first data port,
send to the transaction server a request for transaction data, the request comprising the transaction identifier using the first data port,
receive reply data from the transaction server associated with the transaction identifier using the first data port,
determine a validity of the transaction identifier based on the reply data from the transaction server, and

in response to determining that the transaction identifier is valid
determine the transaction data based on the reply data,
initiate a payment based on the transaction data and associated with the transaction identifier using the first data port,
receive a first payment confirmation associated with the transaction identifier using the first data port, and
send using the second data port a second payment confirmation associated with the transaction identifier to the payee application to allow the payee application to request payment status data from the transaction server.

A method as performed by a transaction server comprises:

authenticating a payee application with the transaction server;

receiving from the payee application first transaction data;

generating a first transaction identifier;

storing the first transaction data associated with the first transaction identifier as a first record of multiple records on a database;

sending the first transaction identifier to the payee application;

authenticating a payment application with the transaction server;

receiving from a payment application a second transaction identifier;

determining a second record of the multiple records that is associated with the second transaction identifier;

determining the second transaction data of the second record;

sending the second transaction data to the payment application;

receiving a payment confirmation associated with a third transaction identifier;

storing in a third record of the multiple records that is associated with the third transaction identifier a first payment status indicative of the payment confirmation;

receiving from the payee application a request for payment status comprising a fourth transaction identifier;

determining a fourth record of the multiple records that is associated with the fourth transaction identifier;

determining whether the fourth record comprises a second payment status that is indicative of a payment confirmation; and

in response to determining that the fourth record comprises a second payment status that is indicative of a payment confirmation sending the second payment status of the fourth record to the payee application.

Software when installed on a server causes the server to perform the above method.

A transaction server comprises:

a communication port to communicate with a payee application and a payment application;

a database to store multiple records of transaction data;

a processor to
authenticate the payee application with the transaction server;
receive from the payee application first transaction data;
generate a first transaction identifier;
store the first transaction data in association with the first transaction identifier as a first record of the multiple records on the database;
send the first transaction identifier to the payee application;
authenticate the payment application with the transaction server;
receive from a payment application a second transaction identifier;
determine a second record of the multiple records that is associated with the second transaction identifier;
determine the second transaction data of the second record;
send the second transaction data to the payment application;
receive a payment confirmation associated with a third transaction identifier;
store in a third record of the multiple records that is associated with the third transaction identifier a first payment status indicative of the payment confirmation;
receive from the payee application a request for payment status comprising a fourth transaction identifier;
determine a fourth record of the multiple records that is associated with the fourth transaction identifier;
determine whether the fourth record comprises a second payment status that is indicative of a payment confirmation;
in response to determining that the fourth record comprises a second payment status that is indicative of a payment confirmation send the second payment status of the fourth record to the payee application.

Optional features described of any aspect of method, computer readable medium or computer system, where appropriate, similarly apply to the other aspects also described here.

### BRIEF DESCRIPTION OF DRAWINGS

An example will be described with reference to

FIG. 1 illustrates a mobile communication device.

FIG. 2a illustrates a method as performed by a payee application for validating a confirmation of a payment.

FIG. 2b illustrates a method as performed by a payment application for initiating a payment.

FIG. 3 schematically illustrates the program memory and data memory of the communication device in FIG. 1 in more detail.

FIG. 4 illustrates a computer network.

FIG. 5 illustrates a home screen displayed on the display of the mobile communication device in FIG. 1.

FIG. 6 illustrates a merchant application user interface.

FIG. 7 illustrates a further merchant application user interface.

FIG. 8 illustrates a payment application user interface.

FIG. 9 illustrates another example of a payment application user interface.

FIG. 10 illustrates a payment confirmation user interface of the merchant application.

FIGS. 11a and 11b illustrate a method as performed by the transaction server in FIG. 4.

FIG. 12 illustrates a table of a database to store transaction data as hosted on data memory of transaction server in FIG. 4.

FIGS. 13a and 13b illustrate state transition graphs of state machines implemented by a merchant application and a payment application, respectively.

### DESCRIPTION OF EMBODIMENTS

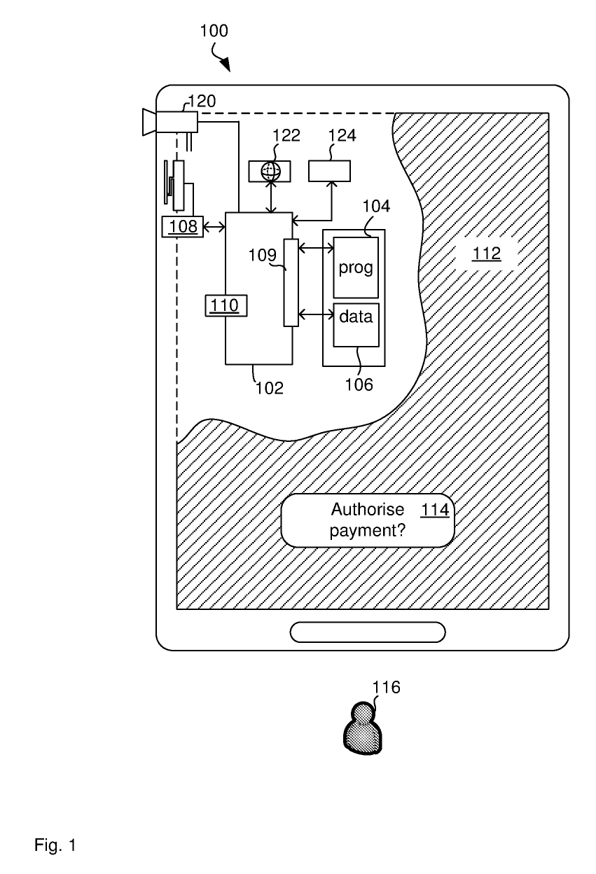

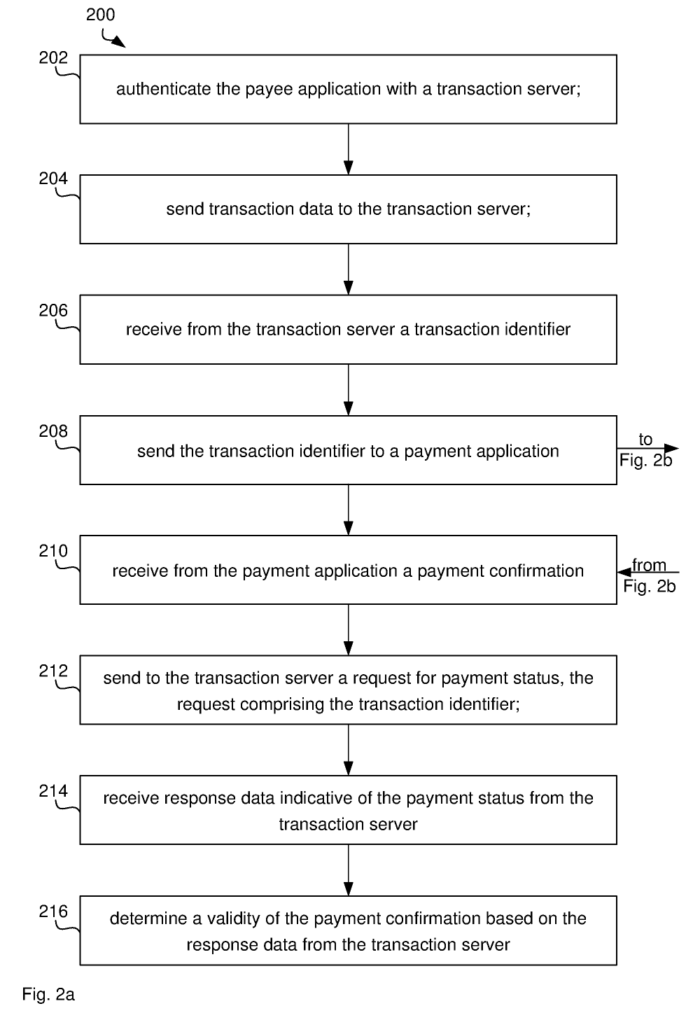

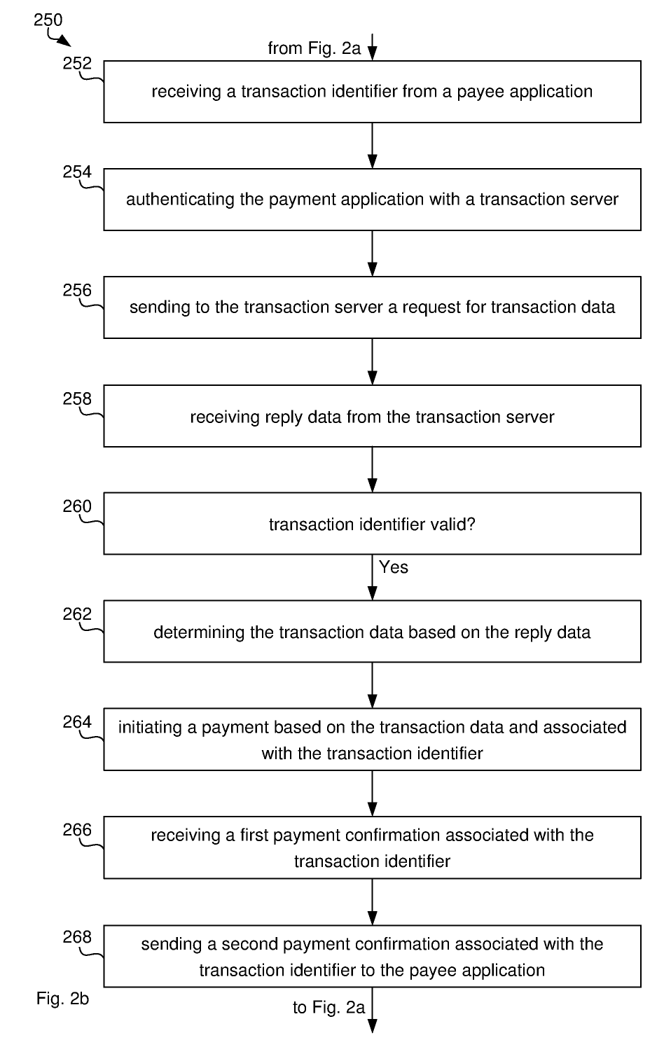

FIG. 1 illustrates a mobile communication device 100, such as a tablet computer or smartphone. The communication device 100 comprises a processor 102 connected to a program memory 104, a data memory 106, a communication port 108, an internal data port 109 and a user port 110. The program memory 104 is a non-transitory computer readable medium, such as a hard drive, a solid state disk or CD-ROM. Software, that is, executable programs stored on program memory 104 cause the processor 102 to perform the methods in FIGS. 2a and 2b for validating a confirmation of a payment and for initiating a payment.

Communication port 108 facilitates communication with external computer systems, such as a transaction server as described below. Internal data port 109 facilitates communication between applications stored on program memory 104, such as communication between a merchant application and banking application as described further below.

The processor 102 may store transaction data on data store 106, such as on RAM or a processor register. The processor 102 may receive data, such as transaction data, from data memory 106 through internal data port 109 as well as from the communications port 108 and the user port 110, which is connected to a display 112 that shows a graphical user interface 114 of a merchant or payment application to a payer 116.

Although communications port 108, internal port 109 and user port 110 are shown as distinct entities, it is to be understood that any kind of data port may be used to receive data or indications of user interaction, such as a network connection, a memory interface, a pin of the chip package of processor 102, or logical ports, such as IP sockets or parameters of functions stored on program memory 104 and executed by processor 102. These parameters may be stored on data memory 106 and may be handled by-value or by-reference, that is, as a pointer, in the source code.

The processor 102 may receive data through all these interfaces, which includes memory access of volatile memory, such as cache or RAM, or non-volatile memory, such as an optical disk drive, hard disk drive, flash drive, storage server or cloud storage.

It is to be understood that any receiving step may be preceded by the processor 102 determining or computing the data that is later received. The processor 102 may request the data from the data memory 106 via internal port 109, such as by providing a read signal together with a memory address. The data memory 106 provides the data as a voltage signal on a physical bit line and the processor 102 receives the data via a memory interface. In this example, mobile communication device 100 further comprises a camera 120, a GPS receiver 122 and an module of inertial sensors 124.

FIG. 2a illustrates a method 200 as performed by a payee application for validating a confirmation of a payment. Payer 116 uses the payee application, such as a merchant application, installed on program memory 104 of the mobile communication device 100 to purchase goods or services.

FIG. 2b illustrates a method 200 as performed by a payment application for initiating a payment. Payer 116 uses the payment application, such as a banking application, installed on program memory 104 of the mobile communication device 100 to check account balances and authorise payments, for example.

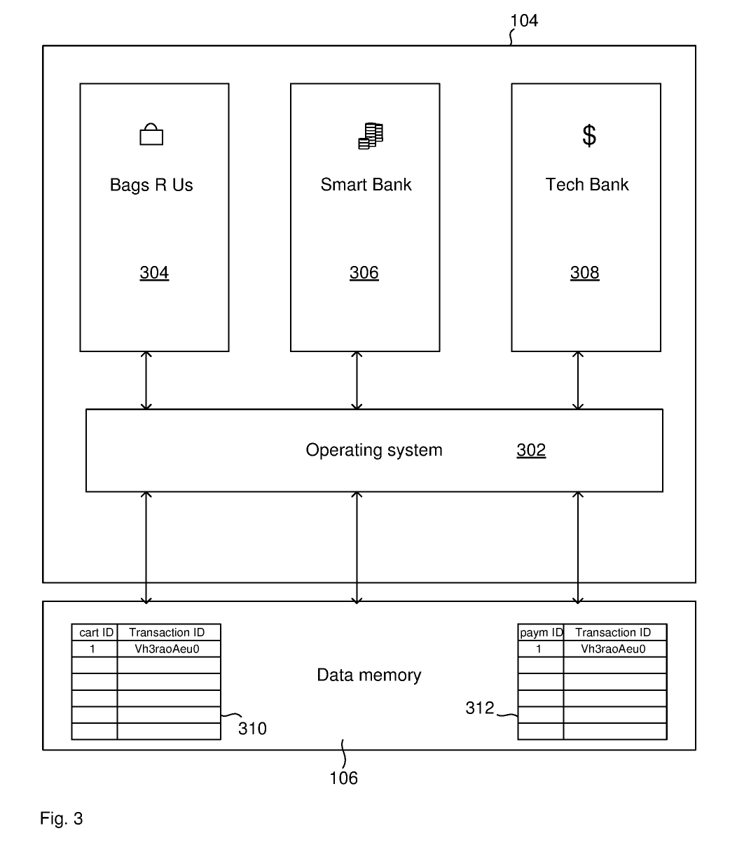

FIG. 3 schematically illustrates the program memory 104 and data memory 106 in more detail. Installed on program memory 104 is an operating system 302, such as Android or iOS, which provides basic functionality and program access to the hardware of the device 100. Also installed on program memory 104 is a merchant application 304, a first payment application 306 and a second payment application 308. It is noted that merchant application 304 may be any application that allows payments to be made, such as a merchant application for purchasing goods or services in an online shop or an online game that allows in-game or in-app purchases, or any other payee application, such as an application for making a payment to a superannuation account or paying bills.

The three applications 304, 306 and 308 communicate with operating system 302 to access hardware functionality, such as creating a user interface on display 112 or receiving user input from payer 116. For example, display 112 may be a touch screen and the user input may be generated by the user selecting controls on the display 112 by tapping the display 112 with one or more fingers. The three applications 304, 306 and 308 also communicate with operating system 302 to access the data memory 106. In one example, merchant application 304 stores a first table 310 of transaction identifiers on data memory 106. Similarly, the second payment application 308 also stores a second table 312 of transaction identifiers on data memory 106. Both tables 310 and 312 may be tables of one or two MySQL databases, for example. The tables 310 and 312 facilitate the monitoring and tracking of pending transactions as described further below.

Each of the two payment application 306 and 308 may be associated with a bank. For example, the payer 116 has an account with a particular bank and accesses an application store, such as Apple's AppStore or Google play to install a payment application. The payer 116 can verify that the provider of the payment application is the actual bank that the payer 116 has an account with.

The three applications 304, 306 and 308 may store data on data store 106. For example, payer 116 may log into the second payment application 308 and second payment application 308 stores the user identifier and login data on data store 106. This way, if the payer 116 wishes to log into the second payment application 308 again after the previous session has expired or after the payer has logged out, the second payment application 308 can retrieve the user identifier from the data store 106, which allows the payer 116 to log into the second payment application 308 without providing the user identifier another time.

Even further, in cases where access to the entire mobile communication device 100 is protected by a secure password or fingerprint sensor etc., the second payment application 308 may require no authentication at all to access account data but may require a password or PIN to authorise payments. The provider of each payment application may provide security rules that govern the use of passwords and other security measures.

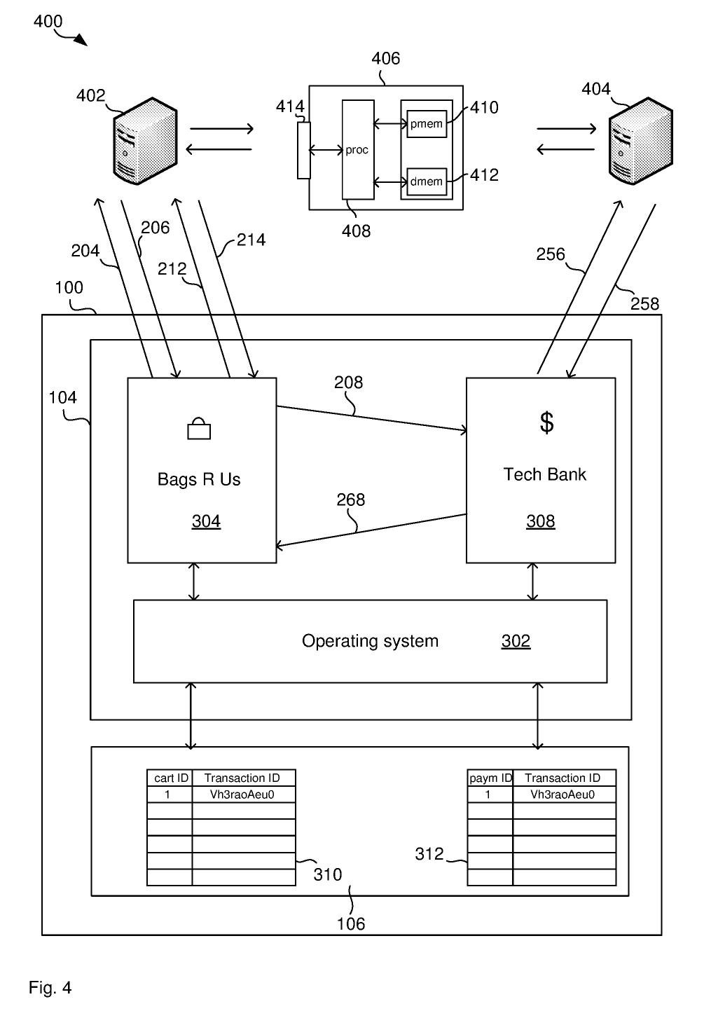

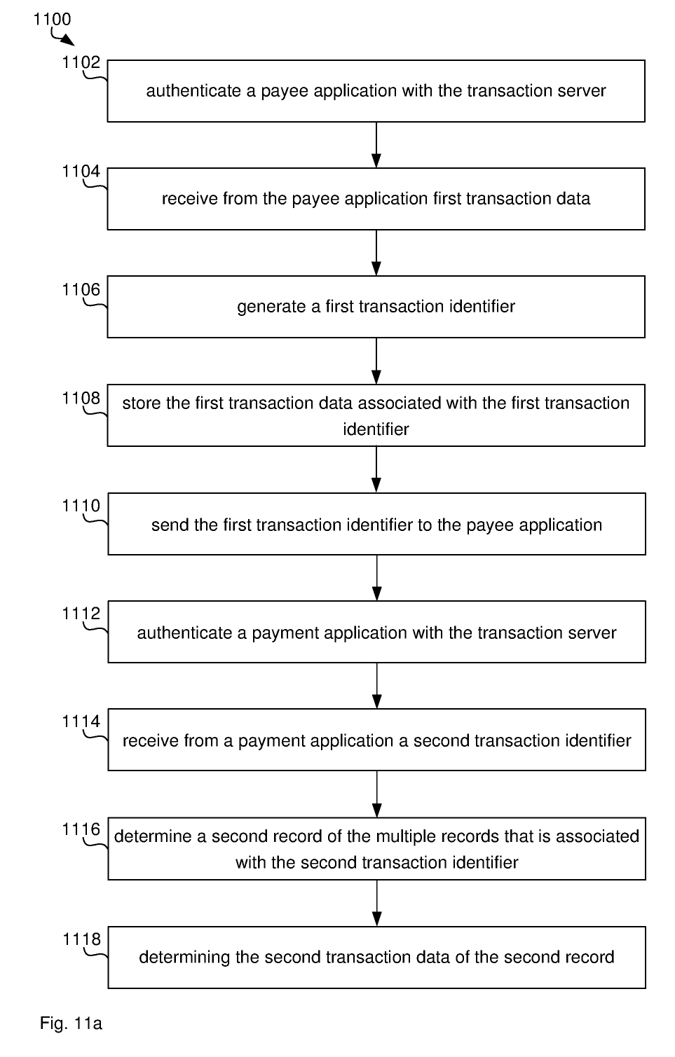

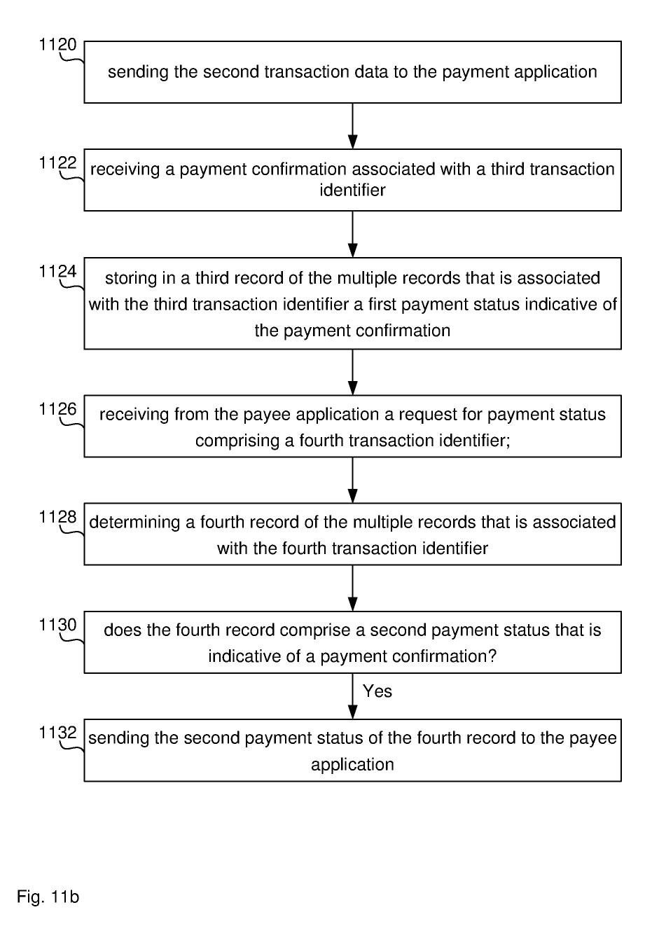

FIG. 4 illustrates a computer network 400 comprising mobile communication device 100 with program memory 104. Installed on program memory 104 are merchant application 304 and payment application 308. The network 400 further comprises a payee server 402, such as the server of a merchant, a payment server 404, such as the server of a bank, and a transaction server 406. The transaction server 406 comprises a processor 408, a program memory 410, a data memory 412 and a communication port 414 to communicate with the merchant application 304 and the payment application 308 via merchant server 402 and payment server 404, respectively. The reference numerals in relation to the arrows relate to steps of methods in FIGS. 2a, 2b, 11 a and 11b. In another example, the transaction server 406 communicates directly with merchant application 304 and payment application 308 without the intermediaries of the merchant server 402 and banking server 404.

The program memory 410 is a non-transitory computer readable medium, such as a hard drive, a solid state disk or CD-ROM. Software, that is, an executable program stored on program memory 410 causes the processor 408 to perform the method in FIGS. 11a and 11b. Comments above in relation to the mobile communication device 100 also apply to the transaction server 406.

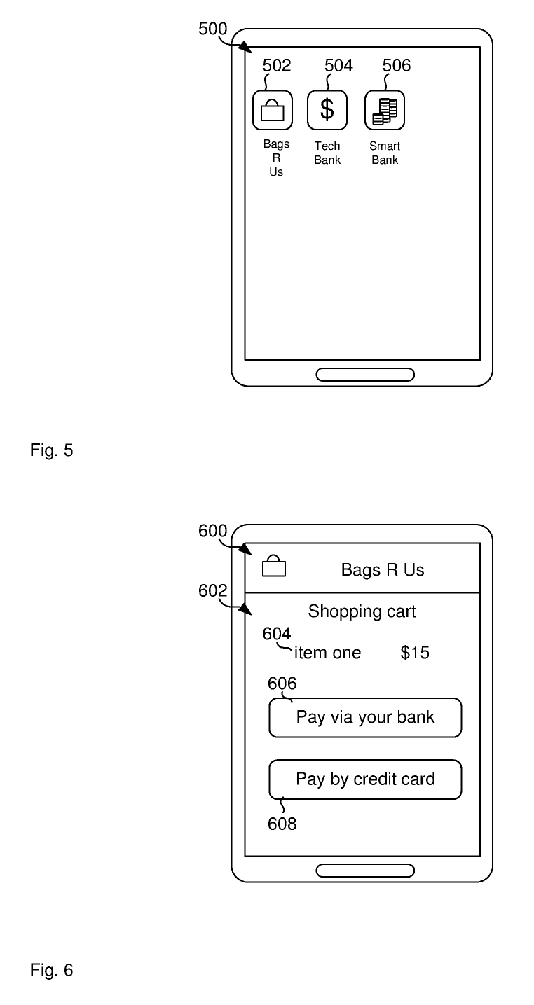

FIG. 5 illustrates a home screen 500 displayed on display 112. Home screen 500 comprises a merchant icon 502 associated with merchant application 304, a first payment icon 504 associated with first payment application 306 and a second payment icon 506 associated with second payment application 308. Although some examples refer to two payment applications 306/308 and 504/506, it is to be understood that more payment applications may also be installed. Payer 116 taps on merchant icon 502 to start merchant application 304.

FIG. 6 illustrates a merchant application user interface 600 displaying a virtual shopping cart 602 having one item 604. Interface 600 further comprises a first user control element 606 that allows payer 116 to make a payment according to methods 200 and 250 and a second user control element 608 that allows payer 116 to make a payment using conventional credit card processes.

In one example, method 200 is implemented as a software development kit (SDK) providing an application programming interface (API). In this example, the merchant can implement the merchant application 306 as usual but includes the API into the application 304, such that the application 304 can call functions of the API to facilitate payment. The API may provide a function ‘generatePaymentControl’ which the merchant application 304 calls. As a result of calling that function, the API generates the first user control element 606 in merchant application user interface 600.

When the payer 116 taps on the first user control element 606, processor 102 detects this interaction by the payer with respect to the merchant application to initiate a payment. For example, the API integrated into the merchant application 304 implements an onClick event handler that causes the following steps to be performed.

In response to detecting the interaction processor 102 selects one of the two payment applications 306 or 308 installed on the mobile communication device. For example, the processor 102 analyses records of all applications that are installed on mobile device 100 and checks which applications are payment applications. Then, processor 102 accesses user preferences to determine whether one of the payment applications is a default payment application and selects the default payment application.

Further, processor 102 may access application data to determine whether the payment applications 306 and 308 are configured to be used for in-app payments, that is, whether they accept payment data from merchant applications. In one example, this application data is a flag associated with the application. This flag may be provided by financial institutions implementing the respective payment application.

As the SDK implementing method 200 is adopted by more users, banks may increasingly implement their payment applications such that they can receive data from merchant applications to allow in-app purchases. When payer 116 then updates the payment applications through conventional means, such as an app store, the new version is installed that provides the functionality of receiving data from the merchant application.

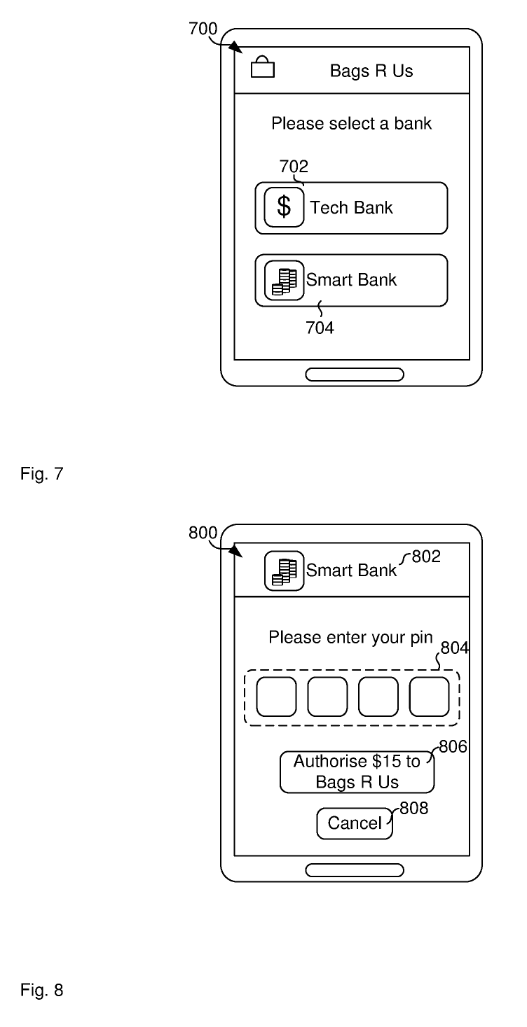

FIG. 7 illustrates a further merchant application user interface 700 that allows payer 116 to select a bank. User interface 700 comprises a first user selection control 702 associated with the first payment application 306 and a second user selection control 704 associated with second payment application 308. Payer 116 taps one of the controls 702 and 704 and processor 102 receives an indication of which of the controls 702 and 704 was selected by the user, such as by calling a further onClick event handler. Based on this indication, processor 102 selects one of the two payment applications 306 and 308.

In this example, processor 102 determines that both payment applications 306 and 308 accept payment data from a merchant application 304 and payer 116 decides to pay using the second payment application 308 and therefore, payer 116 taps second user selection control 704.

In response to receiving the selection 704, processor 102 activates the second payment application 308 to allow the payer 116 to interact with the second payment application 116 using a graphical user interface provided by the second payment application 116. Activating may comprise starting a process of the payment application 308, also referred to launching the payment application 308, if the payment application 308 is not running. Activating may also comprise bringing the payment application 308 into focus if the payment application is already running but the screen 112 is taken up by the merchant application 304. Processor 102 may identify a process that is associated with the second payment application 308, such as by performing commands ‘ps’ and ‘grep’ to find the appropriate process.

Referring back to FIG. 2a, before processor 102 activates the payment application, processor 102 authenticates 202 the merchant application 304 with the transaction server 406. This authentication may comprise establishing a secure socket layer (SSL) connection with transaction server 406 directly. In another example, processor 102 establishes a secure connection with merchant server 402 with a request to authenticate the merchant application 304 with the transaction server 406, that is, processor 102 establishes an indirect connection to transaction server 406. In both cases, the merchant application 304 is said to authenticate the merchant application 304 with the transaction server 406.

In one example, each merchant application that is allowed to participate in this process is registered with the transaction server 406. The transaction server 406 may have a list of merchant application identifiers and each registered merchant application may have a unique private key to provide a signature that can only be generated by that merchant application. This private key may be common to all copies of the merchant application installed on different mobile communication devices or may be different for each copy. Another example of authenticating the merchant application 304 is using a challenge-response process.

In yet another example, the merchant application 304 uses an existing secure connection with merchant server 402 and merchant server 402 is registered with transaction server 406, such as based on a private key. In this example, the merchant application 304 authenticates itself via the merchant server 402.

As the merchant application 304 is authenticated with the transaction server 406 it is difficult for an attacker to provide false transaction data and therefore, the process is more secure.

The merchant application 304 sends 204 transaction data to the transaction server 406. This step 204 of sending transaction data may also comprise instructing the merchant server 402 to send transaction data to the transaction server 406. For example, while the mobile communication device 100 displays a shopping cart as illustrated in FIG. 6, the actual data that represents that shopping cart is stored on merchant server 402. Therefore, when the payer 116 taps on control button 606 to pay via a bank, the merchant application 304 sends instructions to the merchant server 402 to send transaction data to the transaction server 406. This is also referred to as the merchant application 304 sending transaction data to the transaction server 306.

In one example, the transaction data comprises the payment amount and account information of the merchant. Other data may also be included into the payment data, such as data related to purchased items, the merchant name or a customer reference for the payer 116 as generated by the merchant.

It is to be noted that steps 202 and 204 may be combined into a single step, such as by sending a single message with the transaction data that is digitally signed.

Next, processor 102 receives 206 from the transaction server a transaction identifier and stores the transaction identifier on first table 310. In this example, the received transaction identifier is associated with the payment data that the merchant application 304 has sent to the transaction server 406. For example, the reply message from the transaction server 406 that includes the transaction identifier also includes a reference to the transaction data, such as a unique reference generated by the merchant application 304. This unique reference may be the cart identifier as stored in table 310. As the transaction identifier is associated with the payment data, the merchant application 304 can link the received transaction identifier to the purchase by payer 116 that is currently pending.

In another example, merchant application 304 performs step 206 before step 204, that is merchant application first sends a request for a transaction identifier to transaction server 406, receives the transaction identifier and then sends the transaction data to the transaction server 406 associated with the transaction identifier. For example, the message from the merchant application to the transaction server 406 comprises the transaction data and the transaction identifier that was previously generated by the transaction server 406 and sent to the merchant application 304.

The transaction identifier is meaningless for all entities except the transaction server 406 itself because the transaction server 406 is the only entity that has the mapping available from the transaction identifier to the transaction data.

Once the payment application 308 is activated or at the same time as activating the payment application 308, processor 102 sends 208 the transaction identifier to payment application 308 to allow the payment application 308 to access the transaction data from the transaction server.

In one example, processor 102 sends the transaction identifier in plain text in the form of a URL when activating the application 308, such as “secondApp?transaction_identifier=Vh3raoAeu0”. In this example, the transaction identifier is a random string Vh3raoAeu0.

Referring now to FIG. 2b, the payment application 308 receives 252 the transaction identifier from the payee application 302, such as by reading the URL parameter above, and stores the transaction identifier on second table 312. Similar to above, the processor 102 authenticates 254 the payment application 308 with the transaction server 406 and sends 256 to the transaction server a request for transaction data. This request comprises the transaction identifier to identify the transaction record that payment application 308 wishes to access.

Similar to what has been described above, the payment application 308 may communicate directly with transaction server 406 or may communicate indirectly via banking server 404. Again, a secure communication channel between the payment application 308 and the payment server 404 may be used and the payment server 404 may facilitate the authentication of the payment application 308 with the transaction server 406.

Next, processor 102 receives 258 reply data from the transaction server. The reply data is associated with the transaction identifier such that processor 102 can determine that the reply data belongs to the request sent in step 256. For example, the reply data my comprise the transaction identifier.

The reply data indicates whether the transaction identifier exists in the database of the transaction server 406 or whether the transaction identifier does not exist. Processor 102 then reads the reply data and determines the validity of the transaction identifier based on the reply data from the transaction server. In one example, the reply data is XML data and comprises the tag <IdLookUp IdValid=True/>. The value ‘True’ indicates that the transaction identifier is valid.

In another example, the transaction server 406 responds by sending transaction data, which also indicates that the transaction identifier is valid and processor 102 determines the validity of the transaction identifier based on whether transaction data is returned or whether no transaction data is returned.

In response to determining that the transaction identifier is valid the processor 102 determines 262 the transaction data based on the reply data, such as by parsing XML strings from the reply data. Processor 102 then initiates 264 the payment based on the transaction data and associated with the transaction identifier. Initiating the payment may comprise authorisation of the payment by the payer 116, such as by requesting a PIN input from the payer 116 as described below.

FIG. 8 illustrates a payment application user interface 800 of payment application 308. The payment application user interface 800 is displayed as a result of the processor 102 activating payment application 308 to initiate the payment. User interface 800 comprises a name display 802 of the financial institution that is associated with this payment application 308 or that has issued payment application 308. This way, payer 116 can see that the display is now controlled by trusted payment application 308 and not by the potentially untrusted merchant application 304.

User interface 800 further comprises a pin input field 804 that allows the payer 116 to interact with the payment application 308 by providing a pin or other authentication data that is associated with the corresponding financial institution. Of course, the pin input field 804 may be replaced by a more general password input field to authenticate the payer 116 with the second payment application 308. The payer 116 enters the secret pin into pin input field 804 and selects an authorise control field 806. Alternatively, the payer 116 may change his mind and select a cancel control field 808.

In this example, authorisation control 806 further comprises information relating to the purchase in the merchant application 304 that is available to the payment application 308 as received from transaction server 406 as described above. In FIG. 8, the payment data is the payment amount and the merchant name. As a result, the payer 116 is under control which payment will be authorised by selecting the authorise control 706.

Attackers may try to replicate the user interface 800 in order to obtain the pin of the payer 116 and then make unauthorised payments to their advantage. However, the payer 116 can verify the correct payment amount 806. The correct amount is available only to payment applications that can authenticate themselves with transaction server 406 and the transaction identifier does not contain this information. As a result, when a user sees the correct amount on control 806, the user can be confident that the user interface 800 is actually generated by the trusted payment application.

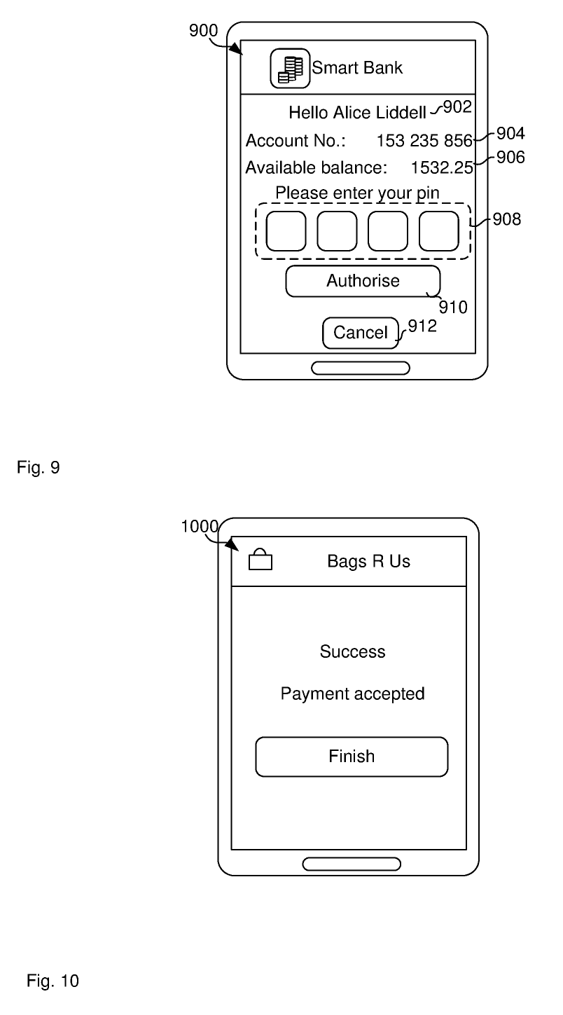

FIG. 9 illustrates another example of a payment application user interface 900. In this example, payer 116 is already logged into payment application 308 as described above. As a result, payment application 308 can access the payer's personal data that is stored by payment application 308 and therefore maintained by the payer's financial institution. In this example, payment application user interface 900 displays the payer's name 902, the payer's account number 904 with the financial institution and the available balance 906.

Since this information is only available to payment application 308 and no other application, payer 116 can verify that the payment application user interface 900 is generated by the correct payment application 308 and not by a fraudulent application that aims to intercept the user's secret pin number for malicious purposes. Similar to the user interface 800 in FIG. 8, the user interface in FIG. 9 comprises a pin input field 908, an authorise control 910 and a cancel control 912.

Processor 102, that is, payment application 308, detects this interaction of payer 116 with control 806/908 and in response, progresses the payment of the given amount to the given merchant. In one example, payment application 308 sends a payment request to payment server 404 in a similar way as the payment application 308 would process any other payment that was defined by the payer 116 instead of the merchant application 304. This concludes step 264 of initiating the payment.

The payment server 404 processes the payment and sends a payment confirmation back to the payment application 308. The payment application 308 receives the payment confirmation that is associated with the transaction identifier stored is second table 310. For example, the payment confirmation from payment server 404 includes the transaction identifier together with an indication that the funds have been cleared and/or transferred. The payment application 308 can match the received transaction identifier against pending transaction identifiers stored in second table 310 to determine to which application the confirmation should be sent.

The payment application 308 sends a payment confirmation 268 to merchant application 304 to allow the merchant application 304 to request payment status data from the transaction server 406. Since the payment confirmation is associated with the transaction identifier, the payment confirmation does not need to contain sensitive of confidential data and therefore, the payment application may send the payment confirmation in plain text. Payment application 308 then activates the merchant application 304.

Referring back to FIG. 2a, the merchant application 304 receives 210 the payment confirmation associated with the transaction identifier from the payment information. For example, the payment confirmation may comprise the transaction identifier. In other examples, the payment confirmation comprises an indication of the transaction identifier, such as an index that associates the payment confirmation with a particular transaction identifier. Merchant application 304 can match the payment confirmation with the transaction identifiers stored in first table 308.

The merchant application 304 then sends 212 to the transaction server 406 a request for payment status. This request comprises the transaction identifier and the transaction server 406 responds with response data that may include a payment confirmation or an indication that the payment has not been successful. For example, the response data may be an XML data packet, such as <responseData transactionID=Vh3raoAeu0 status=confirmed/>.

The merchant app 304 receives 214 the response data indicative of the payment status from the transaction server 404 and determines 216 a validity of the payment confirmation based on the response data from the transaction server. For example, the merchant app 304 parses the received XML data packet and queries the value of the status parameter. If the status is ‘confirmed’ then the payment confirmation is validated.

FIG. 10 illustrates a payment confirmation user interface 1000 that is displayed as a result of the processor 102 determining the validity of the payment confirmation. The merchant application 304 informs payer 116 that the payment has been successful and that the goods or services are now available, that is, the goods are being shipped to a specified delivery address, media items are ready for download or special game features are now accessible.

It is noted here that the communication between the merchant application 304 and the payment application 308 does not contain personal information or otherwise sensitive information, such as the payer's name or address or credit card information. As a result, the communication between these application may be implemented with a low standard of security and encryption and may even be in plain text.

Transaction server 404 or a different server (not shown) may manage payment applications and hosts a list of all payment applications that are registered.

FIGS. 11a and 11b illustrate a method 1100 as performed by processor 408 of transaction server 406. First, processor 408 authenticates merchant application 304 with the transaction server. As described earlier, this may involve verifying a signature using a public key, performing a challenge-response method or establishing an SSL connection.

Once the merchant application 304 is authenticated, processor 408 receives 1104 transaction data from the payee application. As described above, the authentication 1102 and receiving the transaction data 1104 may be performed in a single step by verifying a signature of the transaction data.

Processor 408 generates 1106 a first transaction identifier and stores 1108 the first transaction data associated with the first transaction identifier as a first record of multiple records on a database.

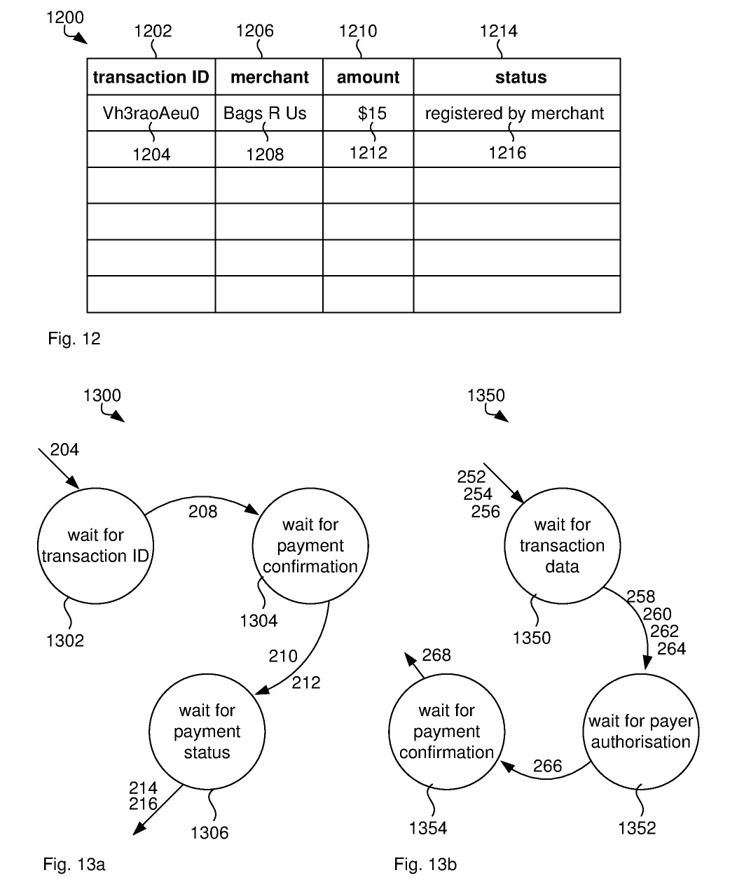

FIG. 12 illustrates a table 1200 of a database to store transaction data as hosted on data memory 412 of transaction server 406 or on a SAN or other external storage system. Table 1200 comprises a transaction ID column 1202 to store the generated transaction identifier 1204. In one example, processor 408 uses the transaction identifier as a primary key when accessing the table 1200. Table 1200 further comprises a merchant column 2106 to store the merchant name 1208. In other examples, the merchant column 1206 stores a merchant identifier and a further table (not shown) stores the merchant data associated with the merchant identifier. The merchant data may include a merchant name, bank account number and bank reference number.

Table 1200 further comprises an amount column 1210 to store the amount 1212 of the transaction as received from the merchant application 304 and a status column 1214 to store a status 1216 identifier that is generated by the transaction server 404 to monitor and audit the different transactions. At this stage, the status 1216 of this transaction is “registered by the merchant”. It is noted here that the name of the payer 116 is not stored associated with the transaction in table 1200. It is not necessary for payer 116 to provide any personal information, such as name, address or credit card number and as a result, table 1200 comprises only data related to the merchant and the transaction. Table 1200 may comprise further information related to the transaction, such as a list of items, amount of tax, any discounts, etc. This further information may also be stored in a separate table and table 1200 stores only references to that further table.

Once the data is stored in table 1200, processor 408 sends the transaction identifier 1204 to the merchant application 304.

The next step in method 1100 is that processor 408 authenticates 1112 a payment application 308 with the transaction server 404 as described above. It is noted that the steps 1102, 1104, 1106 1108 and 1110 and the step 1112 including the following steps may be performed concurrently for different transaction. That is, processor 408 may receive transaction data from multiple different merchant applications before processor 408 authenticates the first payment application. As a result, table 1200 stores multiple records of transaction data where each record is represented as one row in table 1200 and each record is associated with the transaction identifier by storing the transaction identifier in that row as shown in FIG. 11.

Processor 408 then receives 1114 from payment application 308 a further transaction identifier. Since table 1200 stores many different records of transaction data, processor 408 determines 1116 a record of the multiple records that is associated with the received transaction identifier and determines 1118 the transaction data of the record that has the received transaction identifier.

Now referring to FIG. 11b, processor 408 sends 1120 the determined transaction data to the payment application 308 and changes status 1216 to “transaction data sent to payment application”. The payment application 308 requests authorisation of the payment from the payer 116 as described above. The payer 116 authorises the payment which prompts the payment server 404 to process the payment, such as by electronic funds transfer. Once the payment server 404 finalises the payment, that is, the funds are cleared, the payment server issues a payment confirmation. This payment confirmation is associated with the transaction identifier. Processor 408 receives 1122 this payment confirmation associated with the transaction identifier from the payment server and changes the status 1216 to “payment confirmed by payment server”, which means processor 408 stores 1124 in a record of the multiple records that is associated with the received transaction identifier the payment status that is indicative of the payment confirmation received from the payment server 404.

Processor 408 then receives 1126 from the payee application a request for payment status comprising a further transaction identifier and determines 1128 the record of table 1200 that is associated with the received transaction identifier.

Processor 408 then determines 1128 whether the identified record comprises a second payment status that is indicative of a payment confirmation. In response to determining that the record comprises a payment status that is indicative of a payment confirmation, the processor 408 sends the payment status of that record to the merchant application 304, such as in an XML data message.

FIGS. 13a and 13b illustrate state transition graphs 1300 and 1350 of state machines implemented by merchant application 304 and payment application 308, respectively. Reference numerals on the arrows between two states indicate steps in FIG. 2a or 2b that are performed during or that trigger the transition between those two states.

State transition diagram 1300 comprises a first state 1302 where the merchant application 304 waits for the transaction identifier after sending the transaction data to the transaction server 404. During a second state 1304 merchant application 304 waits for a payment confirmation from payment application 308 after sending the transaction identifier to the payment application 308. During a third state 1306, merchant application 304 waits for a payment status from the transaction server 404 after receiving the payment confirmation from payment application 308 and sending a request for payment status to the transaction server 406.

State transition diagram 1350 comprises a first state 1350 where the payment application 308 waits for transaction data after the payment application 308 has received the transaction identifier from the merchant application 304 and has sent a request for transaction data to the transaction server 406. During a second state 1352 the payment application 308 waits for payer authorisation after receiving the transaction data from the transaction server 406 and displaying a pin input field to the payer 116 as shown in FIGS. 8 and 9. During a third state 1354 the payment application waits for payment confirmation from the payment server 404 after receiving the authorisation from the payer 116.

Each of the state machines 1300 and 1350 may be implemented by an ‘ enum’ variable with three allowed values and each state transition is represented by a change of the variable to reflect the state transition.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilising terms such as “estimating” or “processing” or “computing” or “calculating”, “optimising” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A method as performed by a payee application installed on a mobile communication device to validate a confirmation of a payment, the method comprising:
authenticating the payee application with a transaction server;
sending transaction data to the transaction server;
receiving from the transaction server a transaction identifier;
sending the transaction identifier to a payment application installed on the mobile communication device to allow the payment application to access the transaction data from the transaction server;
receiving from the payment application a payment confirmation associated with the transaction identifier;
sending to the transaction server a request for payment status, the request comprising the transaction identifier;
receiving response data indicative of the payment status from the transaction server; and
determining a validity of the payment confirmation based on the response data from the transaction server.

2. The method of claim 1, wherein sending the transaction identifier comprises sending the transaction identifier in plain text.

3. The method of claim 1, wherein the step of sending the transaction data is performed before receiving the transaction identifier and receiving the transaction identifier comprises receiving the transaction identifier associated with the transaction data.

4. The method of claim 1, further comprising:
sending a request for a transaction identifier to the transaction server, wherein
the steps of sending the request for a transaction identifier and receiving the transaction identifier are performed before sending the transaction data, and
sending the transaction data comprises sending the transaction identifier.

5. The method of claim 1, wherein the steps of sending the transaction data, receiving the transaction identifier, sending a request for payment status and receiving response data comprises using a direct communication channel between the payee application and the transaction server.

6. The method of claim 5, wherein using the direct communication channel comprises using an encrypted communication channel between the payee application and the transaction server.

7. The method of claim 6, wherein using an encrypted communication channel comprises using an Secure Socket Layer communication channel.

8. The method of claim 1, wherein the steps of sending the transaction data, receiving the transaction identifier, sending a request for payment status and receiving response data comprises using an indirect communication channel between the payee application and the transaction server via a payee server.

9. The method of claim 8, wherein using the indirect communication channel comprises using an encrypted communication channel between the payee application and the payee server.

10. The method of claim 9, wherein using an encrypted communication channel comprises using an Secure Socket Layer communication channel.

11. The method of claim 1, wherein sending the transaction identifier to the payment application comprises performing a call of the payment application using the transaction identifier as a parameter value of the call.

12. The method of claim 11, wherein performing a call to the payment application comprises generating a Uniform Resource Locator comprising the transaction identifier as a parameter.

13. (canceled)

14. A non-transitory computer readable medium with an executable program stored thereon that when executed causes a computer to perform the method of claim 1.

15. An Application Programming Interface that when installed on a mobile communication device as part of a payee application causes the mobile communication device to perform the method of claim 1.

16. A mobile communication device comprising:
a program memory to store a payee application installed on the mobile communication device and a payment application installed on the mobile communication device;
a first data port to facilitate communication with a transaction server;
a second data port to facilitate communication between the payee application and the payment application; and
a processor to
authenticate the payee application with a transaction server using the first data port;
send transaction data to the transaction server using the first data port;
receive from the transaction server a transaction identifier using the first data port;
send the transaction identifier to the payment application using the second data port to allow the payment application to access the transaction data from the transaction server using the first data port;
receive from the payment application a payment confirmation associated with the transaction identifier using the second data port;
send to the transaction server a request for payment status using the first data port, the request comprising the transaction identifier;
receive response data indicative of the payment status from the transaction server using the first data port; and
determine a validity of the payment confirmation based on the response data from the transaction server.

17. (canceled)

18. A method as performed by a payment application installed on a mobile communication device to initiate a payment, the method comprising:
receiving a transaction identifier from a payee application installed on the mobile communication device;
authenticating the payment application with a transaction server;
sending to the transaction server a request for transaction data, the request comprising the transaction identifier;
receiving reply data from the transaction server associated with the transaction identifier;
determining a validity of the transaction identifier based on the reply data from the transaction server; and
in response to determining that the transaction identifier is valid
determining the transaction data based on the reply data,
initiating a payment based on the transaction data and associated with the transaction identifier,
receiving a first payment confirmation associated with the transaction identifier, and
sending a second payment confirmation associated with the transaction identifier to the payee application to allow the payee application to request payment status data from the transaction server.

19. The method of claim 18, wherein sending the payment confirmation comprises sending the payment confirmation in plain text.

20. The method of claim 18, wherein the steps of
receiving the transaction identifier;
sending the request for transaction data; and
receiving reply data;
comprises using an indirect communication channel between the payment application and the transaction server via a payment server.

21. A non-transitory computer readable medium with an executable program stored thereon that when executed causes a computer to perform the method of claim 18.

22. A mobile communication device comprising:
a program memory to store a payee application installed on the mobile communication device and a payment application stored on the mobile communication device;
a first data port to facilitate communication with a transaction server;
a second data port to facilitate communication between the payee application and the payment application; and
a processor to
receive a transaction identifier from a payee application installed on the mobile communication device using the second data port,
authenticate the payment application with a transaction server using the first data port,
send to the transaction server a request for transaction data, the request comprising the transaction identifier using the first data port,
receive reply data from the transaction server associated with the transaction identifier using the first data port,
determine a validity of the transaction identifier based on the reply data from the transaction server, and
in response to determining that the transaction identifier is valid
determine the transaction data based on the reply data,
initiate a payment based on the transaction data and associated with the transaction identifier using the first data port,
receive a first payment confirmation associated with the transaction identifier using the first data port, and
send using the second data port a second payment confirmation associated with the transaction identifier to the payee application to allow the payee application to request payment status data from the transaction server.

23. A method as performed by a transaction server, the method comprising:
authenticating a payee application with the transaction server;
receiving from the payee application first transaction data;
generating a first transaction identifier;
storing the first transaction data associated with the first transaction identifier as a first record of multiple records on a database;
sending the first transaction identifier to the payee application;
authenticating a payment application with the transaction server;
receiving from a payment application a second transaction identifier;
determining a second record of the multiple records that is associated with the second transaction identifier;
determining the second transaction data of the second record;
sending the second transaction data to the payment application;
receiving a payment confirmation associated with a third transaction identifier;
storing in a third record of the multiple records that is associated with the third transaction identifier a first payment status indicative of the payment confirmation;
receiving from the payee application a request for payment status comprising a fourth transaction identifier;
determining a fourth record of the multiple records that is associated with the fourth transaction identifier;
determining whether the fourth record comprises a second payment status that is indicative of a payment confirmation; and
in response to determining that the fourth record comprises a second payment status that is indicative of a payment confirmation sending the second payment status of the fourth record to the payee application.

24. A non-transitory computer readable medium with an executable program stored thereon that when executed causes a computer to perform the method of any one of claim 23.

25. A transaction server comprising:
a communication port to communicate with a payee application and a payment application;
a database to store multiple records of transaction data;
a processor configured to:
authenticate the payee application with the transaction server;
receive from the payee application first transaction data;
generate a first transaction identifier;
store the first transaction data in association with the first transaction identifier as a first record of the multiple records on the database;
send the first transaction identifier to the payee application;
authenticate the payment application with the transaction server;
receive from a payment application a second transaction identifier;
determine a second record of the multiple records that is associated with the second transaction identifier;
determine the second transaction data of the second record;
send the second transaction data to the payment application;
receive a payment confirmation associated with a third transaction identifier;
store in a third record of the multiple records that is associated with the third transaction identifier a first payment status indicative of the payment confirmation;
receive from the payee application a request for payment status comprising a fourth transaction identifier;
determine a fourth record of the multiple records that is associated with the fourth transaction identifier;
determine whether the fourth record comprises a second payment status that is indicative of a payment confirmation;
in response to determining that the fourth record comprises a second payment status that is indicative of a payment confirmation send the second payment status of the fourth record to the payee application.
